(19) United States
(12) Patent Application Publication
(10) Pub. No.: US 2023/0088618 A1
(43) Pub. Date: Mar. 23, 2023

(54) PEER SENSOR DEVICE ACCURACY MONITORING

(71) Applicant: AT&T Intellectual Property I, L.P., Atlanta, GA (US)

(72) Inventors: Barrett Kreiner, Woodstock, GA (US); James Pratt, Round Rock, TX (US); Adrianne Binh Luu, Atlanta, GA (US); Robert T. Moton, JR., Alpharetta, GA (US); Walter Cooper Chastain, Atlanta, GA (US); Ari Craine, Marietta, GA (US); Robert Koch, Peachtree Corners, GA (US)

(21) Appl. No.: 17/483,774

(22) Filed: Sep. 23, 2021

(51) Int. Cl. G06Q 30/02

(52) U.S. Cl. CPC G06Q 30/0282

(57) ABSTRACT

A processing system including at least one processor may collect first data of at least one first sensor device associated with an external metric, collect second data of a second sensor device associated with the external metric, and calculate a discrepancy between the first data and the second data. The processing system may then determine an accuracy of the second sensor device based upon the discrepancy and generate a report indicative of the accuracy of the second sensor that is determined.

The present disclosure relates generally to network-connected sensor devices, and more particularly to methods, computer-readable media, and apparatuses for generating a report indicative of an accuracy of a second sensor device that is determined based upon a discrepancy between first data of a first sensor device and second data of the second sensor device associated with an external metric.

### BACKGROUND

Current trends in wireless technology are leading towards a future where virtually any object can be network enabled and Internet Protocol (IP) addressable. The pervasive presence of wireless networks, including cellular, Wi-Fi, ZigBee, satellite and Bluetooth networks, and the migration to a 128-bit IPv6-based address space provides the tools and resources for the paradigm of the Internet of Things (IoT) to become a reality. In addition, the household use of various sensor devices is increasingly prevalent. These sensor devices may relate to biometric data, environmental data, premises monitoring, and so on.

### SUMMARY

In one example, the present disclosure describes a method, computer-readable medium, and apparatus for generating a report indicative of an accuracy of a second sensor device that is determined based upon a discrepancy between first data of at least one first sensor device and second data of the second sensor device associated with an external metric. For example, a processing system including at least one processor may collect first data of at least a first sensor device associated with an external metric, collect second data of a second sensor device associated with the external metric, and calculate a discrepancy between the first data and the second data. The processing system may then determine an accuracy of the second sensor device based upon the discrepancy and generate a report indicative of the accuracy of the second sensor that is determined.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates examples of collected sensor data and corresponding reports indicative of sensor device accuracies that are determined;

FIG. 3 illustrates a flowchart of an example method for generating a report indicative of an accuracy of a second sensor device that is determined based upon a discrepancy between first data of a first sensor device and second data of the second sensor device associated with an external metric; and

FIG. 4 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

Examples of the present disclosure provide for methods, computer-readable media, and apparatuses for generating a report indicative of an accuracy of a second sensor device that is determined based upon a discrepancy between first data of a first sensor device and second data of the second sensor device associated with an external metric. In particular, examples of the present disclosure provide for sensor devices (also referred to herein as data collectors) to evaluate and report on how well other sensor devices perform, and in some examples to report on their own performances. In one example, the sensor devices may include virtual assistants. Performance evaluations may be with regards to the accuracy of sensor devices in the collection of data, e.g., measurement of external metric, and/or use of data to predict future events. In one example, sensor devices reporting on each other's performance capabilities may assist users to know which sensor devices or products containing such sensor devices may perform relatively better or worse when making a purchase or deployment decision.

In one example, a system may contain two or more sensor devices. The system may be used to report on the performance of one of the sensor devices based on an analysis the sensor device's performance in the collection of data by other sensor device(s). In one example, a sensor device may also report on its own performance in the analysis of the data that it collects. To illustrate, in one example, a user may have two or more sensor devices, such as a fitness tracker (e.g., a chest worn fitness tracker, smart clothing, which may include an embedded biometric sensor), smart watch, smartphone, and smart shoes, each of which may collect biometric data. In addition, there may be an overlap in capabilities of the sensor devices. For example, the smartwatch and the fitness tracker may both collect heart rate data, the fitness tracker and the smart shoe may both collect data describing the length of the user's walking or running stride, the distance traveled, the number of steps taken, and so forth.

In one example, the user may verify the accuracy of one of the sensor devices. For instance, the user may verify that the fitness tracker is accurate via experimentation or calibration. The fitness tracker may therefore be designated as the standard, or reference sensor device, and its ability to collect accurate data is taken to be confirmed. Alternatively, if multiple sensor devices are collecting the same data over a period of time, a performance assessment server may determine which of the sensor devices most consistently tracks the overall average of all of the sensor devices. The server may thus designate that particular sensor device to be the standard, or reference sensor device among the group of sensor devices with respect to that particular metric.

Over time, both the fitness tracker and the smart shoes may collect data describing the user's walking stride and send the respective collected data to a performance assessment server. In addition, the data may be stored in a data collection database that is accessible to the server for analysis. Over time, the server may analyze the data of both sensor devices (e.g., the fitness tracker and smart shoes) against the verified reference sensor device (e.g., the fitness tracker). If the fitness tracker's own average data varies beyond a threshold over time, the standard norm may be adjusted—since physiological changes or other factors may result in such a change. For instance, the user's average stride may lengthen or shorten over time, e.g., due to improved strength or technique, or due to injury, overtraining, tiredness, etc. This approach relies on the reference sensor device, since verified, to remain as the standard source of accuracy. If the smart shoes' average data varies beyond a threshold over time as compared to the fitness tracker, then the smart shoes may be determined to be inaccurate versus the verified reference. In one example, the variance may be reported by the server by sending an alert to the user, such as to the user's smartphone.

Furthermore, the data collection database may also contain a model identifier (ID) for each sensor device. In one example, the performance assessment server may send reports to one or more servers associated with the one or more websites (e.g., e-commerce site(s)) on the performance of different types of sensor devices, e.g., identified by model ID. In one example, the performance assessment server may provide a scaled rating, such as a star rating, a rating on a scale of 0 to 10, etc., based on the extent of deviation of the collected data of the sensor device compared to the reference sensor device, such as based on the extent of exceeding an error threshold (e.g., the percent or number of instances of disagreement by more than the error threshold, the differences in each measurement (e.g., how far off are the measurements), etc.). In one example, the report may be presented as though the smart shoes, as one data collector, is rated by another data collector—in this case, the fitness tracker.

In another example, a system may include multiple motion sensors tasked with detecting motion in an area. For instance, sensor devices may comprise multiple cameras, each a different model type, but all configured to activate upon the detection of motion or another external trigger. Although the cameras may have different fields-of-view, each of the cameras may individually have within its field-of-view a common coverage area. Thus, for instance, if there is motion within the common coverage area, each of the cameras should activate if performing at 100% accuracy. On the other hand, if camera 1 does not activate while cameras 2 and 3 do activate, then cameras 2 and 3 can in effect report on camera 1's failing. In a similar manner, the cameras, as data collectors, may rank their peers.

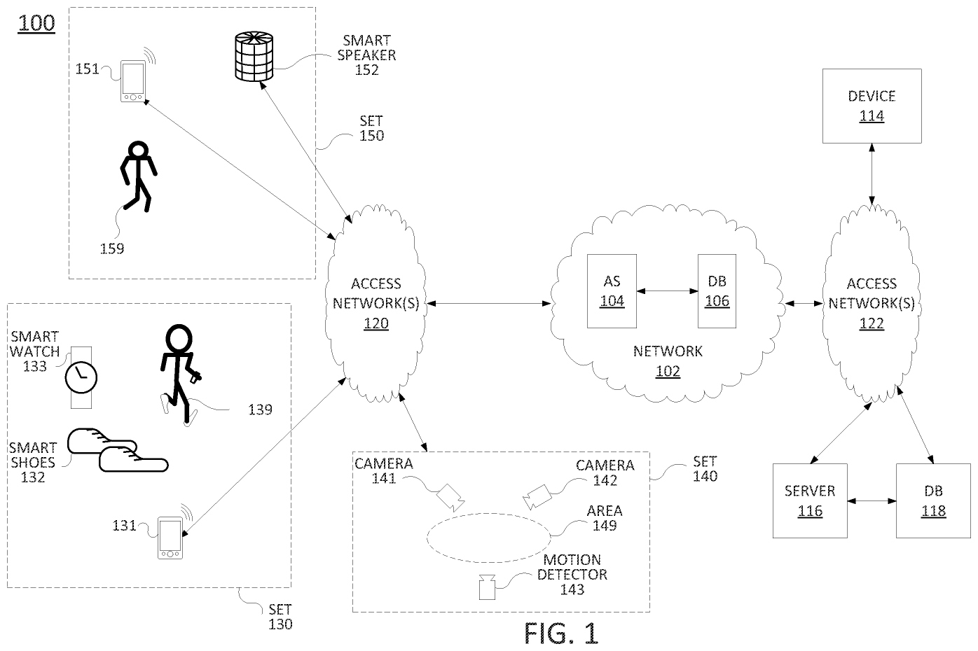

In another example, as system may include multiple sensor devices comprising virtual assistants associated with a user. For example, a first virtual assistant may be embodied as a mobile smartphone comprising a virtual assistant application while a second virtual assistant may comprise a smart speaker. Over time, the data collected by the first and second virtual assistants may be compared over similar tasks and reported to the performance assessment server, which may then analyze the results and provide insights to the user. As an example, the performance task to be assessed may be as to whether smartphone virtual assistant or the smart speaker virtual assistant is more accurate in determining the identity of a speaker, or identities of multiple speakers (e.g., one or more human users). In one example, the virtual assistants may self-report to the user or to the performance assessment server on their relative performances. In another example, the performance assessment server may obtain data from both virtual assistants (e.g., data identifying each detected speaker, a time of the identification, etc.), and evaluate the accuracy of one of the virtual assistants against the other, which may comprise a standard, reference sensor device similar to the other examples above. In one example, one of the virtual assistants or performance assessment server may provide one or more ratings of another of the virtual assistants for one or a number of factors, where the rating(s) may be published on one or more websites. The multiple factors may include how well the virtual assistant identifies wake words, how well the virtual assistant identifies a speaker, how well the virtual assistant detects an input language, and so forth. These and other aspects of the present disclosure are discussed in greater detail below in connection with the examples of FIGS. 1-4.

To further aid in understanding the present disclosure, FIG. 1 illustrates an example system 100 in which examples of the present disclosure for generating a report indicative of an accuracy of a second sensor device that is determined based upon a discrepancy between first data of a first sensor device and second data of the second sensor device associated with an external metric may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, 4G, 5G and the like), a long term evolution (LTE) network, and the like, related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a core network 102. The core network 102 may be in communication with one or more access networks 120 and 122, and the Internet (not shown). In one example, core network 102 may combine core network components of a cellular network with components of a triple play service network; where triple-play services include telephone services, Internet services and television services to subscribers. For example, core network 102 may functionally comprise a fixed mobile convergence (FMC) network, e.g., an IP Multimedia Subsystem (IMS) network. In addition, core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 102 may further comprise a broadcast television network, e.g., a traditional cable provider network or an Internet Protocol Television (IPTV) network, as well as an Internet Service Provider (ISP) network. In one example, core network 102 may include a plurality of television (TV) servers (e.g., a broadcast server, a cable head-end), a plurality of content servers, an advertising server (AS), an interactive TV/video-on-demand (VoD) server, and so forth. For ease of illustration, various additional elements of core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of core network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one embodiment, the core network 102 may be operated by a telecommunication network service provider. The core network 102 and the access networks 120 and 122 may be operated by different service providers, the same service provider or a combination thereof, or may be operated by entities having core businesses that are not related to telecommunications services, e.g., corporate, governmental or educational institution LANs, and the like. In one example, each of access networks 120 and 122 may include at least one access point, such as a cellular base station, non-cellular wireless access point, a digital subscriber line access multiplexer (DSLAM), a cross-connect box, a serving area interface (SAI), a video-ready access device (VRAD), or the like, for communication with various endpoint devices.

In one example, the access networks 120 may be in communication with various devices in device sets 130, 140, and/or 150. Similarly, access networks 122 may be in communication with one or more devices, e.g., device 114, server 116, database (DB) 118, etc. Access networks 120 and 122 may transmit and receive communications between devices in device sets 130, 140, and/or 150, and server 116 and/or database (DB) 118, application server (AS) 104 and/or database (DB) 106, other components of core network 102, devices reachable via the Internet in general, and so forth.

In one example, a first device set 130 may include a mobile computing device 131, e.g., a cellular smartphone, a non-cellular wireless communication device (e.g., a tablet computing device, a Wi-Fi device, etc.), or the like. In accordance with the present disclosure, mobile computing device 131 may include one or more sensors for tracking location, speed, distance, altitude, or the like (e.g., a Global Positioning System (GPS) unit), for tracking orientation (e.g., gyroscope and compass), and so forth. As illustrated in FIG. 1, the first device set 130 may further include smart shoes 132 (e.g., shoes with one or more embedded sensors for tracking distance traveled, stride length, contact pressure, steps taken, and/or other metrics) and a smart watch 133, which may comprise one or more sensors for tracking location, speed, distance, altitude, steps taken, or the like (e.g., a GPS unit), for tracking orientation (e.g., gyroscope and compass), for measuring heart rate/pulse, skin conductance, blood oxygen, or the like, and so forth.

In one example, each of these sensor devices (mobile computing device 131, smart shoes 132, and smart watch 133) may communicate independently with access networks 120. In another example, one or more of these sensor devices may comprise a peripheral device that may communicate with remote devices, servers, or the like via access networks 120, network 102, etc. via another endpoint device. For instance, smart shoes 132 may be paired with the mobile computing device 131 via a near-field connection, such as IEEE 802.15 based communications (e.g., Bluetooth or the like), where mobile computing device 131 may have a cellular or non-cellular wireless connection to access networks 120. Thus, in one example, smart shoes 132 may upload data to server 116 via mobile computing device 131, access networks 120, etc. In one example, mobile computing device 131 may include an application (app) for pairing with smart shoes 132, for establishing communication with server 116 to upload data from smart shoes 132, and so forth. In one example, smart watch 133 may be similarly paired with mobile computing device 131 via a near-field connection.

In another example, a second device set 140 may include a plurality of motion sensors, or motion detection sensors, e.g., camera 141, camera 142, and motion detector 143. As illustrated in FIG. 1, each of these sensor devices may have an overlapping area 149 within the respective field-of-view of each device. As in the previous example, each of the camera 141, camera 142, and motion detector 143 may have separate connections to access networks 120 (e.g., via cellular or non-cellular links with a wireless access point, or via wired connection with an access point of access networks 120). However, in another example, one or more of the camera 141, camera 142, or motion detector 143 may have a wired or wireless connection to another local device that may have a connection to access networks 120. For instance, camera 142 may be in communication with camera 141, which may have a connection to access networks 120 (e.g., where camera 142 does not have an independent connection to access networks 120), or both of the cameras 141 and 142 may be in communication with another device (not shown), such as a smart home hub, which may have a connection to access networks 120.

In still another example, a third device set 150 may include a mobile computing device 151, e.g., a cellular smartphone, a non-cellular wireless communication device (e.g., a tablet computing device, a Wi-Fi device, etc.), or the like. In accordance with the present disclosure, mobile computing device 151 may include a virtual assistant application. The third device set 150 may also include a smart speaker 152 (e.g., including another virtual assistant application). For instance, both virtual assistant applications may perform similar tasks, which may include wake word detection, or speaker identification/detection, such as distinguishing user 159 from others speakers, among other capabilities.

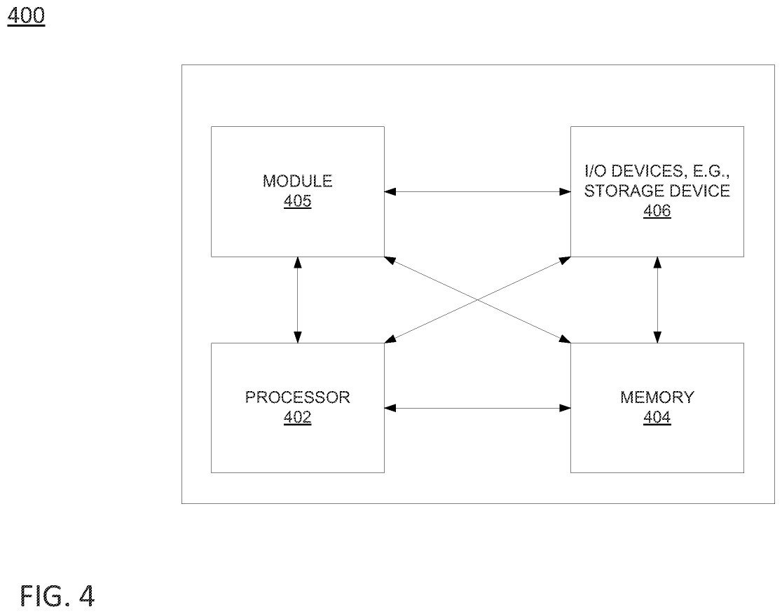

In one example, any one or more of the devices in sets 130, 140, or 150 may each comprise programs, logic or instructions for generating a report indicative of an accuracy of a second sensor device that is determined based upon a discrepancy between first data of a first sensor device and second data of the second sensor device associated with an external metric as described herein. For example, any of such devices may each comprise a computing system or device, such as computing system 400 depicted in FIG. 4, and may be configured to provide one or more operations or functions for generating a report indicative of an accuracy of a second sensor device that is determined based upon a discrepancy between first data of a first sensor device and second data of the second sensor device associated with an external metric.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

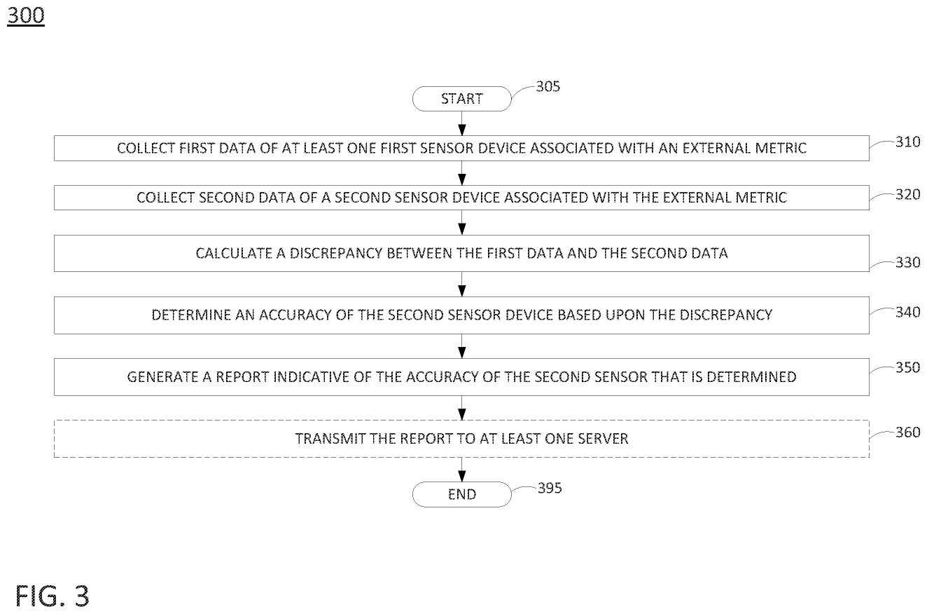

As illustrated in FIG. 1, access networks 122 may be in communication with a server 116 and a database (DB) 118. In accordance with the present disclosure, server 116 may comprise a computing system or server, such as computing system 400 depicted in FIG. 4, and may be configured to perform operations or functions for generating a report indicative of an accuracy of a second sensor device that is determined based upon a discrepancy between first data of a first sensor device and second data of the second sensor device associated with an external metric (such as illustrated and described in connection with the example method 300 of FIG. 3). For instance, server 116 may comprise a performance assessment server as described above. In one example, DB 118 may comprise a physical storage device integrated with server 116 (e.g., a database server), or attached or coupled to the server 116, to store various types of information in support of systems for generating a report indicative of an accuracy of a second sensor device that is determined based upon a discrepancy between first data of a first sensor device and second data of the second sensor device associated with an external metric, in accordance with the present disclosure. For example, DB 118 may store data from various sensor devices (e.g., devices in any one or more of sets 130, 140, or 150), which may be used by server 116 to determine the accuracies of different sensor devices (e.g., where one or more of the sensor devices may comprise a reference sensor device, and where data of such sensor device(s) may be compared to the data of one or more other sensor devices with regard to the same external metric to determine the accuracies of such other devices). In addition, DB 118 may store rankings/ratings of different sensor device types/models, e.g., indexed by model ID, or the like.

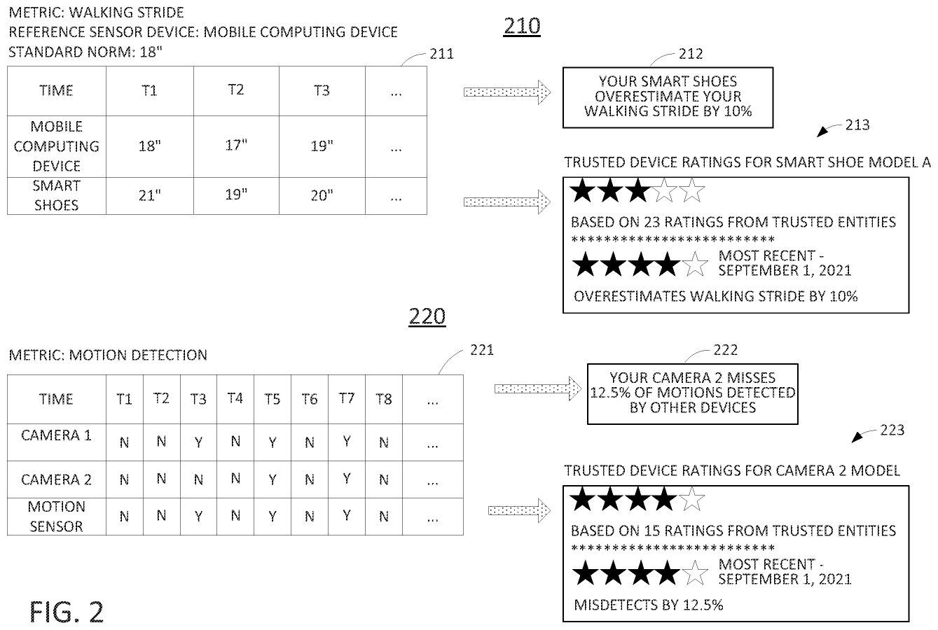

In an illustrative example, server 116 may be tasked with collecting sensor data, determining accuracies of different sensor device types/models, and publishing reports indicative of the accuracies of the different sensor device types/model. For instance, servers 116 may collect sensor data from mobile computing device 131, smart shoes 132, and smart watch 133 and store such sensor data in DB 118. Alternatively, or in addition, computing device 131, smart shoes 132, and/or smart watch 133 may upload such sensor data in DB 118. Over a period of time, server 116 may retrieve the respective sensor data, from which server 116 may determine an accuracy of one or more of the sensor devices with respect to the sensor data of a reference sensor device. For instance, the smart watch 133 may be established as a “standard,” or reference sensor device, e.g., at least with respect to the metric of interest of “average stride length.” Thus, the sensor data of smart watch 133 comprising “stride length” data may be taken as a reference data set. A similar set of data may also be collected from smart shoes 132 over the same time period. The stride length metrics may be stored in DB 118, and may be accessed by server 116, which may determine a discrepancy between the data set from the smart watch 133 and the data set from the smart shoes 132. For instance, the average stride lengths over rolling 1 minute periods may be determined. In addition, an average of the discrepancies, e.g., over 50 time periods, 100 time periods, etc. may be calculated. The average discrepancy between the average stride length as determined by the smart watch 133 and the average stride length as determined by smart shoes 132 may then be determined and reported. In one example, the report may be provided to a user of the devices in set 130, e.g., user 139. For instance, the report may be provided in a message to mobile computing device 131. In one example, the report may alternatively or additionally be provided to other users, such as a user of device 114. For instance, device 114 may access a website that rates and/or makes available for purchase one or more sensor device models, including at least a sensor device model of the smart shoes 132 (e.g., a particular make and model of smart shoes). In one example, the website may be hosted by server 116, or server 116 may provide a report regarding smart shoes 132 to another server or servers hosting such as website. Illustrative ratings and reports are depicted in FIG. 2 and discussed in greater detail below.

It should be noted that the foregoing is just one example of establishing an accuracy of a sensor device in accordance with sensor data of a reference sensor device and that other, further, and different examples may be established in connection with the sensor device set 130. For instance, in another example, mobile computing device 131 may be established as a reference sensor device with respect to a metric of “speed.” As such, server 116 may determine the accuracies of smart watch 133 and smart shoes 132 for the metric of “speed” with reference to the speed data of mobile computing device 131 as compared to the speed data from smart watch 133 and smart shoes 132. In one example, if smart shoes 132 and smart watch 133 have speed measurements that are in agreement greater than a threshold number or percentage of times, while the corresponding speed data for the same time period(s) from mobile computing device 131 are not in agreement (e.g., having measurements values differing by a threshold percentage for more than a threshold number of times or percentage of measurements), then the status of the mobile computing device 131 as a reference sensor device accorded by server 116 may be revoked or may be temporarily suspended unless and until the mobile computing device 131 can be re-verified as being accurate/in agreement with other reference sensor devices with respect to the same metric. For instance, user 139 may borrow a friend's smart watch that has also been accorded status as a reference sensor device for “speed” and may perform a test run over a defined distance and/or time. If the mobile computing device 131 produces speed data that is in agreement with the friend's smart watch, then the status of the mobile computing device 131 as a reference sensor device for “speed” may be reinstated. On the other hand, if there is no agreement, then the loss of status may be maintained. For instance, the mobile computing device 131 may have been damaged in some way that it is no longer accurate with respect to the metric of speed and furthermore should not be trusted to establish the accuracies of any other sensor devices, such as smart shoes 132 and smart watch 133.

In another example, server 116 may collect and store (e.g., in DB 118) sensor data in the form of motion detection data from camera 141, camera 142, and motion detector 143. In this example, camera 141 may be a reference sensor device for determining the accuracies of camera 142 and motion detector 143. In one example, cameras 141 and 142 may be similar, but may be different models from the same or different manufacturers, for instance. In one example, cameras 141 and 142 may include motion detection sensors that activate video recording. In such case, the motion detection data may comprise a time series indicating whether there is motion detected or not detected (or whether the respective camera has been activated or not). In another example, camera 141 and/or camera 142 may have a continuous active video capture, from which motion detection may be performed via a machine learning (ML)-based algorithm or other computer-implemented video analysis. On the other hand, for illustrative purposes, motion detector 143 may comprise an infrared or other line-of-sight light-based motion detector (e.g., a light-trip sensor). Thus, although motion detector 143 may operate in an entirely different manner from cameras 141 and 142, the collected sensor data is of the same format (e.g., time series indicative of whether motion was detected at any given time within area 149 or not). In any case, the accuracies of camera 142 and/or motion detector 143 may be determined by server 116 via a comparison of the motion sensor data of camera 142 and/or motion detector 143 to that of the reference sensor device, camera 141. In addition, server 116 may report on the accuracy, or accuracies to an owner or operator of the device set 140, to a website for rating and/or facilitating purchases of device models of camera 142 and/or motion detector 143, to other users, such as a user of device 114 seeking information on such device model(s), and so forth.

In another example, there may be no established reference sensor device in the set 140. However, server 116 may calculate accuracies of each of camera 141, camera 142, and motion detector 143 based upon how often each individual device is in agreement or not in agreement with the other two sensor devices. Thus, for example, if camera 142 and motion detector 143 detect an instance of motion in the area 149, but camera 141 does not, server 116 may observe that this is an occurrence of camera 141 being inaccurate. Over time, server 116 may establish a percentage of instances in which any one of these devices fails to agree with the other two, where the percentage may then be reported as an accuracy, or accuracy score. (It should be noted that when all three sensors are in agreement, this may be considered as an instance of accurate performance for all three sensors).

With respect to the third device set 150, a virtual assistant application of mobile computing device 151 may comprise a reference sensor device, e.g., for voice identification/recognition. In this example, server 116 may collect data from mobile computing device 151 and smart speaker 152, which may be deployed in the same environment, such as within the same room. For instance, the data (e.g., “sensor data”) may be regarding whether a human speaker is detected, and the determined identity of the speaker (for instance, distinguishing user 159 from other members of a family or from non-family members who may be present and speaking). As such, server 116 may determine the accuracy of smart speaker 152 by comparison of the speaker detection/identification data of smart speaker 152 to that of the reference sensor device, mobile computing device 151. Similar to the above examples, server 116 may report on the accuracy of smart speaker 152 to an owner or operator of the device set 150 (e.g., user 159), to a website for rating and/or facilitating purchases of the device model of smart speaker 152, to other users, such as a user of device 114 seeking information on such device model, and so forth. It should be noted in connection with this example that the particular detected identity or identities of speakers are not required to be shared with servers 116, but may be tagged by a non-personally identifiable user ID, such as user 1, user 2, user 3, etc. and where server 116 and/or DB 118 does not store such speaker identification data any longer than necessary to calculate the accuracy of the virtual assistant of smart speaker 152. Furthermore, such analysis would be performed only when the user has authorized or opted into this monitoring and analysis service to protect the data privacy of the user.

Although only a single server 116 and a single DB 118 are illustrated, it should be noted that any number of servers 116 or databases 118 may be deployed. In one example, core network 102 may also include an application server (AS) 104 and a database (DB) 106. In one example, AS 104 may perform the same or similar functions as server 116. Similarly, DB 106 may store the same or similar information as DB 118 (e.g., sensor device data, rankings of sensor device types, etc.). For instance, core network 102 may provide a service to subscribing websites and/or user devices in connection with accuracy rankings/ratings of different sensor device types/models, e.g., in addition to television, phone, and/or other telecommunication services. In one example, AS 104, DB 106, server 116, and/or DB 118, or any one or more of such devices in conjunction with one or more of devices in sets 130, 140, and/or 150, may operate in a distributed and/or coordinated manner to perform various steps, functions, and/or operations described herein.

In this regard, it should be noted that in another example, aspects of the foregoing described in connection with server 116 may alternatively or additionally be performed by sensor devices in device sets 130, 140, and/or 150. As just one example, mobile computing device 131 may collect its own measurements/sensor data, and may collect similar measurements/sensor data regarding the same external metric, e.g., speed of movement of user 139, distance traveled, stride length, etc. from smart shoes 132 and smart watch 133. Mobile computing device 131 may then determine the accuracy of either or both of smart shoes 132 or smart watch 133 by way of comparison to mobile computing device 131's own measurements as reference sensor data. In addition, mobile computing device 131 may report on the accuracy, or accuracies, e.g., to server 116, to an independent website and/or a website associated with server 116, to AS 140, to device 114, to the user 139, etc.

It should also be noted that in one example, server 116 may grant and deny designations of sensor devices as reference sensor devices, and may maintain records of the statuses/designations of various sensor devices as being reference sensor devices. For instance, in one example, user 139 may verify the accuracy of smart watch 133. For instance, the user may verify that the smart watch 133 is accurate via experimentation or calibration. The smart watch 133 may therefore be designated as a standard, or reference sensor device, and its ability to collect accurate data is taken to be confirmed. Alternatively, if multiple sensor devices are collecting the same data over a period of time, server 116 may determine which of the sensor devices most consistently tracks the overall average of all of the sensor devices. The server 116 may thus designate that sensor device to be the standard, or reference sensor device among the group of sensor devices with respect to a particular metric.

In one example, a sensor device may need to establish a level of credibility over time before it is permitted to start rating other sensor devices, or before its sensor data may be used as a reference data set for determining the accuracies of other sensor devices. For instance, it is possible to have a large number of inferior products that all agree with each other and that are also inaccurate. For example, inferior sensor devices may be more widely deployed due to their lower cost such that collected sensor data from these inferior sensor devices may form a very large portion of the total amount of collected sensor data. These inferior sensor devices could thus establish a false consensus and give erroneous accuracies and reviews for competing sensor devices. In one example, different models from the same manufacturer may also consistently be inaccurate by the same amount, since designs or components may be the same or similar, e.g., the only changes may be the external appearance and housing, the change may be in the wireless transceiver, and not necessarily in the measurement component, and so on. In one example, to prevent these inaccuracies, the number and/or percent of times a sensor device agrees with peers with regard to a same external metric may be counted, and the sensor device may earn a designation as a reference sensor device after both a threshold number of measurements is exceeded and the percent of agreements with other sensor devices also exceeds a threshold (e.g., greater than 90 percent, 95 percent, 98 percent, etc.). Alternatively, or in addition, a sensor device may be designated as a reference sensor device when it is determined that the sensor device has an accuracy above a threshold accuracy with respect to a test scenario.

To illustrate, a user may establish one of camera 141, camera 142, or motion sensor 143 as a reference sensor device by triggering motion intentionally and measuring how many times each sensor device accurately detect the motion. Those that have the highest percentage or most correct detections of the intentional motions will be ranked the highest in terms of credibility and may be designated as a reference sensor device. In one example, the accuracies may be periodically checked and re-evaluated. For example, different camera and/or motion sensors may perform relatively better or worse depending on lighting conditions, some are better in darkness and others are better in the light, and some are in locations that receive more sun light or less sun light at different times of day, etc. In one example, server 116 may detect these changes and may send notifications for devices that are not performing well (e.g., to a user associated with the camera 141, camera 142, and motion sensor 143).

In another example, mobile computing device 131 and smart watch 133 may be certified as being accurate via calibration, e.g., by running a known distance under the instruction of server 116 and the mobile computing device 131 and smart watch 133 sensing the known distance correctly (and in one example, it may also be relevant that these sensor devices agree with each other). For example, the mobile computing device 131 may have an app associated with server 116 that directs user 139 to a known location (e.g., a park or field with designated markers) to perform one or more test runs, such as a 100 meter run, a 400 meter run, a 5 km run, etc. The app and server 116 may confirm the accuracy of the readings from the test runs, and certify one or both of mobile computing device 131 and smart watch 133 as being accurate.

As such, either or both may earn a designation from server 116 as a reference sensor device and may then be permitted to evaluate the smart shoes 132. In this case, it is not user 139 that evaluates the smart shoes 132 and gives a review based on the results. Rather, user 139 may assist to confirm the mobile computing device 131 and smart watch 133 are accurate. Then, these devices may evaluate the smart shoes 132 and provide direct and objective feedback, or server 116 may rely upon the data from mobile computing device 131 and smart watch 133 to perform a similar evaluation of the data from smart shoes 132, bypassing any human input and providing a more objective assessment, which can then be combined with reviews of the same model smart shoe by similar reference sensor devices of other users.

It should be noted that the system 100 has been simplified. Thus, the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of core network 102 and/or access networks 120 and 122 may comprise a content distribution network (CDN) having ingest servers, edge servers, and the like, for packet-based streaming of videos or video segments that may be provided in accordance with the present disclosure. Similarly, although only two access networks 120 and 122 are shown, in other examples, access networks 120 and/or 122 may each comprise a plurality of different access networks that may interface with core network 102 independently or in a chained manner. For example, device 114 and server 116 may access core network 102 via different access networks, devices 110 and 112 may access core network 102 via different access networks, and so forth. Thus, these and other modifications are all contemplated within the scope of the present disclosure.

FIG. 2 illustrates examples of collected sensor data and corresponding reports indicative of sensor device accuracies that are determined. In a first example 210, a computing system, or processing system, such as server 116 of FIG. 1 may obtain sensor data in the form of walking stride data from a mobile computing device and from smart shoes (e.g., mobile computing device 131 and smart shoes 132 of FIG. 1) over a plurality of time periods, e.g., T1-T3. The data may be stored in a sensor data record set 211. In the present example, the mobile computing device may be a reference sensor device. In this case, the processing system may determine that the standard norm for stride length over the plurality of time periods is 18 inches (taken from the average readings/measurements obtained from the mobile computing device). In addition, the processing system may determine that the measurements from the smart shoes indicate that the average stride length over the same time period is 20 inches. As such, the processing system may determine that the smart shoes overestimate the walking stride length by 10%.

A first example notification 212 may be in the form of a message to an owner/user of the mobile computing device and smart shoes. For instance, an app notification of a smart shoe app, a text message, or the like may be transmitted to the mobile computing device with an automatically generated message indicating that “your smart shoes overestimate your walking stride by 10%” or the like. Alternatively, or in addition, the processing system may provide a rating of the smart shoes based upon the deviation determined from the reference measurements, e.g., where the rating may be attributed to the mobile computing device as a trusted device (e.g., as a designated reference sensor device that has been accorded such a designation as described herein). Moreover, the rating may be aggregated with the ratings of other devices or computing systems (e.g., other trusted, designated reference devices that may provide measures of deviation of other smart shoes of a same model type, or that may be used to establish such measures of deviation). For instance, the notification 213 may include an overall ranking of the model of smart shoe (e.g., according to the ratings from a plurality of trusted, reference sensor devices) and may include at least a most recent ranking from a reference sensor device (e.g., the mobile computing device of the sensor data record set 211). The notification 213 may be provided to other users seeking information on the model of smart shoes, e.g., via an e-commerce website or mobile app, as additional information provided along with a push advertisement for the smart shoes, and so forth.

In a next example 220, a computing system, or processing system, such as server 116 of FIG. 1 may obtain sensor data in the form of motion detection data from camera 1, camera 2, and a motion sensor (e.g., 141, 142, and 143 of FIG. 1) over a plurality of time periods, e.g., T1-T8, where the respective sensor devices are tasked with measuring the same external metric, e.g., motion detection within an area. The data may be stored in a sensor data record set 221. In this case, there may be no reference sensor device. However, the processing system may determine the accuracy of a given sensor device based upon a percentage of measurements for which the sensor device is in agreement with its peers. For instance, camera 2 may fail to detect motion at time T3 while camera 1 and the motion sensor agree that motion was detected at T3. Thus, over the entire plurality of time periods T1-T8, the processing system may determine that camera 2 failed to concur with the other sensor devices 12.5% of the time.

A first example notification 222 may be in the form of a message to an owner/user of the cameras and motion sensor. For instance, the processing system may transmit an email, a text message, an app notification of a security camera app, a home security app, or the like to a computing device of a user, where the notification may comprise an automatically generated message indicating that “your camera 2 misses 12.5% of motions detected by other devices,” or the like. Alternatively, or in addition, the processing system may provide a rating of camera 2 based upon the determined accuracy (e.g., 87.5%). Moreover, the rating may be aggregated with the ratings of other devices or computing systems (e.g., other trusted devices or processing/computing systems that may provide measures of deviation of other cameras of a same model type as camera 2). For instance, the notification 223 may include an overall ranking of the model of camera 2 (e.g., according to the ratings from a plurality of trusted entities) and may include at least a most recent ranking from the processing system. For instance, the accuracy of 87.5% may be mapped to a 4 out of 5 star rating. The notification 223 may be provided to other users seeking information on the model of camera 2, e.g., via an e-commerce website or mobile app, as additional information provided along with a push advertisement for the camera model, and so forth. Furthermore, the notification can also be provided directly to the affected sensor, e.g., camera 2 in this example. Responsive to this notification, camera 2 may implement one or more remedial actions such as adjusting one or more of its operating parameters, e.g., perform a self-diagnostic routine, perform a calibration routine, increase or decrease a sensitivity parameter, increase or decrease a sensitivity zone, adjust a field of view of the camera, reposition the camera, or simply apply an adjustment to its collected sensor data based upon the reported percentage of inaccuracy as noted in the notification (e.g., if the sensor's reported measurement is 10% over a verified norm, then the sensor's next reported measurement should be reduced by 10% in the future, or if the sensor's reported measurement is 10% under a verified norm, then the sensor's next reported measurement should be increased by 10% in the future). Alternatively, the processing system may determine one or more remedial actions and transmit an instruction to the affected sensor, e.g., camera 2, to implement the one or more remedial actions.

FIG. 3 illustrates a flowchart of an example method 300 for generating a report indicative of an accuracy of a second sensor device that is determined based upon a discrepancy between first data of a first sensor device and second data of the second sensor device associated with an external metric, in accordance with the present disclosure. In one example, the method 300 is performed by a component of the system 100 of FIG. 1, such as by server 116, application server 104, a device in one of device sets 130, 140, or 150, and/or any one or more components thereof (e.g., a processor, or processors, performing operations stored in and loaded from a memory), by a plurality of the devices in device sets 130, 140, or 150, server 116, or application server 104, or by any one or more of such devices in conjunction with one or more other devices, such as DB 106, DB 118, and so forth. In one example, the steps, functions, or operations of method 300 may be performed by a computing device or system 400, and/or processor 402 as described in connection with FIG. 4 below. For instance, the computing device or system 400 may represent any one or more components of a device, server, and/or application server in FIG. 1 that is/are configured to perform the steps, functions and/or operations of the method 300. Similarly, in one example, the steps, functions, or operations of method 300 may be performed by a processing system comprising one or more computing devices collectively configured to perform various steps, functions, and/or operations of the method 300. For instance, multiple instances of the computing device or processing system 400 may collectively function as a processing system. For illustrative purposes, the method 300 is described in greater detail below in connection with an example performed by a processing system. The method 300 begins in step 305 and proceeds to step 310.

At step 310, the processing system collects first data of at least a first sensor device associated with an external metric. In one example, the processing system may comprise the first sensor device. In another example, the processing system may comprise a server, e.g., a performance assessment server, such as server 116 of FIG. 1 that obtains the first sensor data from the first sensor device. In still another example, the processing system may comprise a user's computing device that is in communication with at least the first sensor device and a second sensor device.

At step 320, the processing collects second data of a second sensor device associated with the external metric. In one example, the external metric is a metric that is external to the sensor devices, or not inherent to the sensor devices (e.g., not the processor speed, memory capacity, battery life, etc. of the respective sensor devices). For example, the external metric may comprise a speed, distance traveled, rotation, stride length, or the like, biometric data, such as heart rate, breathing rate, blood oxygen level, and so forth, motion detection, speaker detection and/or identification, environmental metrics such as temperature, humidity, and so on. In various examples, the first sensor device may comprise at least one of a biometric sensor device of a user, such as a smart watch, a chest worn heart rate monitor (e.g., with or without additional capabilities, such as measuring stride, distance, speed/pace, etc.), or the like, or a mobile endpoint device of the user, and the second sensor device may comprise sensor-equipped shoes of the user (e.g., smart shoes), and vice versa. In another example, the first sensor device may comprise a motion detector and the second sensor device may comprise a surveillance camera, or vice versa. In one example, the first sensor device and the second sensor device may be of a same sensor type, such as a motion detection sensor type, a voice recognition sensor type (e.g., virtual assistants/virtual assistant applications), a biometric sensor type, etc. For instance, both/all of the sensor devices may be cameras (e.g., of different model types), both/all of the sensor devices may be smart speakers (e.g., of different model types), both/all of the sensor device may comprise a same type of biometric device (e.g., smart watches), and so on. In still another example, both/all of the sensor devices may be of a same model type, e.g., where the processing system may determine variances among the same model type, which may be indicative of varying qualities.

At step 330, the processing system calculates a discrepancy between the first data and the second data (e.g., a measure of the discrepancy over multiple time periods/measurements of the first data and second data). For instance, the first sensor device may be a reference sensor device, e.g., at least with respect to the external metric of interest. Thus, the first data may comprise a reference data set, with the second data having similar measurements over the same time period. In one example, the first sensor device is designated as a reference sensor device when it is determined that the first sensor device has an accuracy above a threshold accuracy with respect to a test scenario, such as accurately measuring distance over a test run on a test course, correctly detection intentionally triggered motions, etc. In an example in which the external metric comprises a stride length, the average stride lengths over a plurality of time periods/measurements according to the first data and the second data may be determined. In addition, an average of the differences between the average stride length as determined from the first data and the second data, respectively, e.g., over 50 time periods, 100 time periods, etc. may be calculated. The average discrepancy between the average stride length as determined from the first data and second data over the entirety of the time periods may then be determined. In one example, the number of time periods/measurements may be a configurable parameter selected by an operator of the processing system or may be based upon the number of measurements that are obtainable based upon a user's actions (e.g., if the user goes for a one hour walk, there may be one hour of data/measurements available, if the user goes golfing for five hours (e.g., without a golf cart), there may be five hours of data/measurements available, and so on). The discrepancy may be determined in other ways depending upon the nature of the external metric. For instance, in another example, the first data and second data may comprise time series indicating whether motion is detected or not, whether a human speaker is detected or not, and/or identities of speakers that may be detected over a relevant time block over which the first data and second data are collected, etc.

At step 340, the processing system determines an accuracy of the second sensor device based upon the discrepancy. For instance, the accuracy may be a percentage of data points/measurements of which the second data does not match the first data. Alternatively, or in addition, the accuracy may be scaled based upon magnitudes of the differences in the first data and the second data. For instance, when a measurement in the second data is only slightly off from the corresponding measurement of the first data, the decrease in the accuracy from 100% may be less than when the magnitude of the difference in measurements is greater, and so on for each of the corresponding measurements in the first data and the second data. In one example, only differences in corresponding measurements in the first data and the second data that are over a threshold may negatively impact the assessment of accuracy. For instance, only differences greater than 2% of the value of the measurement in the first data may be counted negatively against the accuracy that is determined for the second sensor device. Various other factors of a same or similar nature may be implemented in determining the accuracy, and the weightings applied to one or more factors may be similarly adjusted and configured by an operator, e.g., based upon the particular type or nature of the external metric, or other considerations.

It should also be noted that in one example, the first sensor device may comprise at least two sensor devices, where the accuracy of the second sensor device may be determined by a percentage of instances of discrepancy between the second data and the first data. For instance, the first sensor device may not necessarily comprise a trusted, reference sensor device. However, where the second sensor device has a measurement in the second data set that does not agree with corresponding measurements from at least two other sensor devices that are in agreement with each other, that may be counted as an instance where the second sensor device is inaccurate. And the overall percentage of such instances over a series of measurements/time periods (e.g., in a time block) may be used in calculating the average accuracy of the second sensor device similar to as discussed above.

At step 350, the processing system generates a report indicative of the accuracy of the second sensor that is determined. In one example, the processing system provides the report to a user of the first sensor device and the second sensor device (e.g., where the processing system is independent of the at least the first sensor device and second sensor device). In one example, the processing system may generate an aggregate report comprising a rating of a model of the second sensor device based upon a plurality of reports from a plurality of entities indicative of a plurality of accuracies of a plurality different instances of the model of the second sensor device, where the plurality of reports includes the report. For instance, each of the plurality of accuracies may be determined by a respective one of the plurality of entities in accordance with a discrepancy between data from an instance of the model of the second sensor device and data from a respective one of a plurality of reference sensor devices (e.g., where the plurality of reference sensor devices may include the first sensor device). Alternatively, or in addition, one or more of the plurality of accuracies may be determined in accordance with a discrepancy between data from an instance of the model of the second sensor device and data from a plurality of peer sensor devices (such as in the example 220 of FIG. 2). In one example, the processing system may publish the rating of the model of the second sensor device via at least one website. For instance, the website may be an online store or a website for promoting a purchase of the model of the second sensor device. In one example, the processing system provides an indication that the rating is generated from a plurality of trusted entities, e.g., reference sensor devices or other trusted automated systems, such as the processing system performing the method 300.

At optional step 360, the processing system may transmit the report to at least one server or even to the second sensor device (e.g., to allow the second sensor device to take a remedial action as discussed above). In one example, the server may generate a rating of a model of the second sensor device based upon a plurality of reports from a plurality of entities indicative of a plurality of accuracies of a plurality different instances of the model of the second sensor device, where the plurality of reports includes the report. For instance, the server may perform this task when not performed by the processing system in accordance with step 350. In another example, the transmitted report may be an aggregate report as mentioned above. In one example, the server may publish the rating of the model of the second sensor device via at least one website. For instance, the website may be for promoting a purchase of the model of the second sensor device. In one example, the server provides an indication that the rating is generated from a plurality of trusted entities, e.g., reference sensor devices or other trusted automated systems, such as the processing system performing the method 300. In another example, the server may host the website and may provide the rating of the model of the second sensor device to requesting clients.

Following step 350 or optional step 360 the method 300 proceeds to step 395 where the method ends.

It should be noted that the method 300 may be expanded to include additional steps, or may be modified to replace steps with different steps, to combine steps, to omit steps, to perform steps in a different order, and so forth. For instance, in one example the processor may repeat one or more steps of the method 300 over different periods of a day or week to ascertain whether the reported inaccuracy can also be verified over such different periods of the day or the week, and so on. In one example, the method 300 may also include the step of transmitting the report to a user of the first sensor device and the second sensor device. In one example, the method 300 may also include using external data to supplement the analysis, e.g., using a venue based sensor data to corroborate the mobile device collected sensor data. For example, a park or track may have deployed sensors that allow a user to ascertain distance traveled and/or elapsed time, where such venue based sensor data can be additionally used as reference data. In one example, the method 300 may further include the processing system instructing the second sensor device to take a particular remedial action as discussed above. In another example, the at least one server may instruct the second sensor device to take a particular remedial action as discussed above. Thus, these and other modifications are all contemplated within the scope of the present disclosure.

In addition, although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 4 depicts a high-level block diagram of a computing device or processing system specifically programmed to perform the functions described herein. For example, any one or more components or devices illustrated in FIG. 1 or described in connection with the examples of FIG. 2 or 3 may be implemented as the processing system 400. As depicted in FIG. 4, the processing system 400 comprises one or more hardware processor elements 402 (e.g., a microprocessor, a central processing unit (CPU) and the like), a memory 404, (e.g., random access memory (RAM), read only memory (ROM), a disk drive, an optical drive, a magnetic drive, and/or a Universal Serial Bus (USB) drive), a module 405 for generating a report indicative of an accuracy of a second sensor device that is determined based upon a discrepancy between first data of a first sensor device and second data of the second sensor device associated with an external metric, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for generating a report indicative of an accuracy of a second sensor device that is determined based upon a discrepancy between first data of a first sensor device and second data of the second sensor device associated with an external metric (e.g., a software program comprising computer-executable instructions) can be loaded into memory 404 and executed by hardware processor element 402 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for generating a report indicative of an accuracy of a second sensor device that is determined based upon a discrepancy between first data of a first sensor device and second data of the second sensor device associated with an external metric (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
collecting, by a processing system including at least one processor, first data of at least one first sensor device associated with an external metric;
collecting, by the processing system, second data of a second sensor device associated with the external metric;
calculating, by the processing system, a discrepancy between the first data and the second data;
determining, by the processing system, an accuracy of the second sensor device based upon the discrepancy; and
generating, by the processing system, a report indicative of the accuracy of the second sensor that is determined.

2. The method of claim 1, further comprising:
transmitting the report to at least one server, wherein the at least one server generates a rating of a model of the second sensor device based upon a plurality of reports from a plurality of entities indicative of a plurality of accuracies of a plurality different instances of the model of the second sensor device, wherein the plurality of reports includes the report.

3. The method of claim 2, wherein each of the plurality of accuracies is determined by a respective one of the plurality of entities in accordance with a discrepancy between data from an instance of the model of the second sensor device and data from a respective one of a plurality of reference sensor devices.

4. The method of claim 3, wherein the plurality of reference sensor devices includes the at least one first sensor device.

5. The method of claim 2, wherein the at least one server publishes the rating of the model of the second sensor device via at least one website.

6. The method of claim 5, wherein the at least one website is for promoting a purchase of the model of the second sensor device.

7. The method of claim 5, wherein the at least one server provides an indication that the rating is generated from a plurality of reference sensor devices.

8. The method of claim 1, wherein the at least one first sensor device comprises a motion detector and wherein the second sensor device comprises a surveillance camera.

9. The method of claim 1, wherein the at least one first sensor device and the second sensor device are of a same sensor type.

10. The method of claim 9, wherein the same sensor type comprises:
a motion detection sensor type;
a voice recognition sensor type; or
a biometric sensor type.

11. The method of claim 10, wherein the voice recognition sensor type comprises a virtual assistant application.

12. The method of claim 1, wherein the processing system comprises the at least one first sensor device.

13. The method of claim 1, wherein the processing system comprises a computing device of a user that is in communication with at least one of: the at least one first sensor device or the second sensor device.

14. The method of claim 1, wherein the report is provided to a user of the at least one first sensor device and the second sensor device.

15. The method of 1, further comprising:
determining whether the at least one first sensor device is a reference sensor device.

16. The method of claim 15, wherein the at least one first sensor device is designated as the reference sensor device when it is determined that the at least one first sensor device has an accuracy above a threshold accuracy with respect to a test scenario.

17. The method of claim 1, wherein the at least one first sensor device comprises at least one of: a first biometric sensor device of a user or a mobile endpoint device of the user, and wherein the second sensor device comprises a second biometric sensor device of the user.

18. The method of claim 17, wherein the first biometric sensor device comprises:
a smartwatch;
a chest-worn fitness tracker; or
smart clothing.

19. A non-transitory computer-readable medium storing instructions which, when executed by a processing system including at least one processor, cause the processing system to perform operations, the operations comprising:
collecting first data of at least one first sensor device associated with an external metric;
collecting second data of a second sensor device associated with the external metric;
calculating a discrepancy between the first data and the second data;
determining an accuracy of the second sensor device based upon the discrepancy; and
generating a report indicative of the accuracy of the second sensor that is determined.

20. An apparatus comprising:
a processing system including at least one processor; and
a computer-readable medium storing instructions which, when executed by the processing system, cause the processing system to perform operations, the operations comprising:
collecting first data of at least one first sensor device associated with an external metric;
collecting second data of a second sensor device associated with the external metric;
calculating a discrepancy between the first data and the second data;
determining an accuracy of the second sensor device based upon the discrepancy; and
generating a report indicative of the accuracy of the second sensor that is determined.
